(19) United States
(12) Patent Application Publication
(10) Pub. No.: US 2007/0103128 A1
(43) Pub. Date: May 10, 2007

(54) DC-DC converter and organic light emitting display using the same

(76) Inventor: Dong Yong Shin, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/527,300

(22) Filed: Sep. 25, 2006

(30) Foreign Application Priority Data
Nov. 7, 2005 (KR) 10-2005-0106168

(51) Int. Cl. G05F 1/00

(52) U.S. Cl. 323/280

(57) ABSTRACT

A DC-DC converter with an improved signal response characteristic and reduced power consumption; and an organic light-emitting display using the same are disclosed. A comparator for receiving an input voltage and a reference voltage and determining an output to correspond to a difference between the input voltage and the reference voltage is disclosed. The comparator uses a feedback mechanism to improve speed without increased power consumption.

### CROSS-REFERENCE TO RELATED APPLICATIONS

This application claims the benefit of Korean Patent Application No. 2005-0106168, filed on Nov. 7, 2005, in the Korean Intellectual Property Office, the disclosure of which is incorporated herein by reference.

### BACKGROUND

1. Field of the Invention

The present invention relates to a DC-DC converter and an organic light-emitting display using the same, and more specifically to a DC-DC converter configured to output a voltage according to a comparison result obtained by comparing an input voltage with a reference voltage; and an organic light-emitting display using the same.

2. Description of the Related Technology

FIG. 1 is a circuit diagram showing a comparator according to the prior art. Referring to FIG. 1, the comparator includes an input unit and first, second and third inverters.

The input unit has a first switch (SW1) for switching the input voltage (Vin); and a second switch (SW2) for switching a reference voltage (Vref).

The first inverter has a first transistor (M1) as the P MOS transistor and a second transistor (M2) as the N MOS transistor. And the first power supply (Vdd) is connected to a source of the first transistor (M1) to output a high level of voltage, and the second transistor (M2) has a source connected to a ground (GND) to output a low level of voltage. Also, the first capacitor (C1) and the third switch (SW3) are connected to the input of the first inverter.

The second inverter has a third transistor (M3) as the P MOS transistor and a fourth transistor (M4) as the N MOS transistor. And the first power supply (Vdd) is connected to a source of the third transistor (M1) to output a high level of voltage, and a ground is connected to a source of the fourth transistor (M4) to output a low level of voltage. And, the second inverter is connected with the first inverter through the second capacitor (C2), and terminals of the second capacitor (C2), the fourth switch (SW4), and the third and fourth transistors (M3,M4) are connected at the output of the second inverter.

The third inverter has a fifth transistor (M5) as the P MOS transistor and a sixth transistor (M6) as the N MOS transistor. And the first power supply (Vdd) is connected to a source of the fifth transistor (M5) to output a high level of voltage, and a ground is connected to a source of the sixth transistor (M6) to output a low level of voltage.

FIG. 2 is a waveform view showing input/output waveforms of the circuit shown in FIG. 1. Referring to FIG. 2, an input voltage (Vin) input to an input terminal of a comparator unit is compared with the reference voltage (Vref). The first to fifth switches (SW1 to SW5) perform a switching operation according to the first control signal (P1) and the second control signal (P2), where the first, third and fourth switches (SW1,SW3,SW4) are operated by the first control signal (P1) and the second and fifth switches (SW2,SW5) are operated by the second control signal (P2).

Firstly, if the first, third and fourth switches (SW1,SW3,SW4) are turned on by the first control signal (P1) and the second and fifth switches (SW2,SW5) are turned off by the second control signal (P2), the input voltage (Vin) is transmitted to the first capacitor (C1), and the voltage corresponding to a threshold voltage difference between the first inverter and the second inverter is stored in the second capacitor (C2).

When the first, third and fourth switches (SW1,SW3,SW4) are turned off by the first control signal (P1) and the second and fifth switches (SW2,SW5) are turned on by the second control signal (P2), the reference voltage (Vref) is transmitted to the first capacitor (C1) to compare the input voltage (Vin) with the reference voltage (Vref).

At this time, if the input voltage (Vin) is higher than the reference voltage (Vref), then an output port of the third inverter outputs a low level of voltage, and if the input voltage (Vin) is lower than the reference voltage (Vref), then an output port of the third inverter outputs a high level of voltage.

In the comparator described above, the output voltage is determined according to a difference between the reference voltage (Vref) and the input voltage (Vin) in the first capacitor (C1), and therefore the comparator has a problem that it takes more time to change the output voltage into the high level or the low level if there is not a large difference between the reference voltage (Vref) and the input voltage (Vin) than if there is large difference between the reference voltage (Vref) and the input voltage (Vin).

In order to solve the problem, the comparator as described above should have a large capacitance, however, it then has a problem that its power consumption is increased because of the large capacitance.

### SUMMARY OF CERTAIN INVENTIVE ASPECTS

Accordingly, the present invention is designed to solve such drawbacks of the prior art, and therefore an aspect of the present invention is to provide a low power comparator with high speed response, and an organic light-emitting display using the same.

One embodiment is a comparator configured to receive an input voltage and a reference voltage and to determine an output corresponding to a difference between the input voltage and the reference voltage. The comparator includes an input unit configured to transmit the input voltage to a first stage and to transmit the reference voltage and a feedback voltage to a second stage, an amplification unit including at least one inverter configured to operate according to the input voltage transmitted to the first stage, the feedback voltage transmitted to the second stage, and the reference voltage, a feedback unit configured to receive a voltage output in the amplification unit so as to generate a feedback voltage and to transmit the generated feedback voltage to the input unit so as to control the voltage transmitted to the amplification unit, and an output unit configured to receive and output the output voltage of the amplification unit.

Another embodiment is a DC-DC converter including a charge pump, and a comparator configured to receive an input voltage and a reference voltage and to determine an output voltage corresponding to a difference between the input voltage and the reference voltage, where the comparator includes an input unit configured to transmit the input voltage to a first stage and to transmit the reference voltage and a feedback voltage to a second stage, an amplification unit including at least one inverter configured to operate according to the input voltage transmitted to the first stage, the feedback voltage transmitted to the second stage, and the reference voltage, a feedback unit configured to receive a voltage output in the amplification unit so as to generate a feedback voltage and to transmit the generated feedback voltage to the input unit so as to control the voltage transmitted to the amplification unit, and an output unit configured to receive and output the output voltage of the amplification unit.

Another embodiment is an organic light-emitting display including a pixel unit configured to display an image corresponding to data signals and scan signals, a data driving unit configured to transmit the data signals to the pixel unit, a scan driving unit configured to transmit the scan signals to the pixel unit, and a DC-DC converter configured to transmit a power supply to the pixel unit, the data driving unit and the scan driving unit. The DC-DC converter includes a charge pump, and a comparator configured to receive an input voltage and a reference voltage and to determine an output voltage corresponding to a difference between the input voltage and the reference voltage, where the comparator includes an input unit configured to transmit the input voltage to a first stage and to transmit the reference voltage and a feedback voltage to a second stage, an amplification unit including at least one inverter configured to operate according to the input voltage transmitted to the first stage, the feedback voltage transmitted to the second stage, and the reference voltage, a feedback unit configured to receive a voltage output in the amplification unit so as to generate a feedback voltage and to transmit the generated feedback voltage to the input unit so as to control the voltage transmitted to the amplification unit, and an output unit configured to receive and output the output voltage of the amplification unit.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a circuit diagram showing a comparator according to prior art;

FIG. 2 is a waveform view showing input/output waveforms of the circuit shown in FIG. 1;

FIG. 3 is a schematic view showing a configuration of an organic light-emitting display according to one embodiment;;

FIG. 4 is a schematic view showing a DC-DC converter used in the organic light-emitting display shown in FIG. 3;

FIG. 5 is a circuit diagram showing one embodiment of the comparator used in the DC-DC converter shown in FIG. 4;

FIG. 6 is a circuit diagram showing one embodiment of the comparator used in the DC-DC converter shown in FIG. 4; and

FIG. 7 is a circuit diagram showing one embodiment of the comparator used in the DC-DC converter shown in FIG. 4.

### DETAILED DESCRIPTION OF CERTAIN INVENTIVE EMBODIMENTS

Hereinafter, embodiments will be described with reference to the accompanying drawings.

FIG. 3 is a schematic view showing a configuration of an organic light-emitting display according to the present invention. Referring to FIG. 3, the organic light-emitting display has a pixel unit 100, a data driving unit 200, a scan driving unit 300 and a DC-DC converter 400.

In the pixel unit 100, a plurality of data lines (D1 to Dm) and a plurality of scan lines (S1 to Sn) cross each other, and pixels 110 are formed near regions in which the data lines (D1 to Dm) and the scan lines (S1 to Sn) cross. The pixels 110 present an image by displaying a grey level corresponding to data signals transmitted through the data lines (D1 to Dm) and scan signals transmitted through the scan lines (S1 to Sn).

The data driving unit 200 is connected with a plurality of the data lines (D1 to Dm) to transmit data signals to a plurality of the data lines in parallel, and to simultaneously transmit data signals to a pixel row arranged in a latitudinal direction of the pixel unit 100.

The scan driving unit is connected with a plurality of the scan lines (S1 to Sn) to transmit data signals to a specific pixel 110 by transmitting the data signals to the pixel 110 to which the scan signals are connected.

The DC-DC converter 400 converts a D.C. power supply voltage, input from the outside, to a suitable D.C. power supply voltage for the electrical loads and transmits the D.C. power supply to each of the electrical loads. The D.C. power supply generated in the DC-DC converter 400 is transmitted to the pixel unit 100, the data driving unit 200 and the scan driving unit 300, etc.

FIG. 4 is a schematic view showing a DC-DC converter used in the organic light-emitting display shown in FIG. 3. Referring to FIG. 4, the DC-DC converter includes a clock switch 430, a charge pump 410, a clock divider 440 and a comparator 420.

The clock switch 430 receives clocks from a clock generation unit (CLK), and controls the clocks generated in the clock generation unit (CLK) using the first clock (CLK1) and the second clock (CLK2) transmitted through the inverter 450.

The charge pump 410 synchronizes with the first clock (CLK1) and the second clock (CLK2), and charges a capacitor so as to generate a higher voltage or lower voltage than the input voltage, and output the voltage generated by the charge pump 410, and then transmit the voltage to each of the driving units. Hereinafter, the circuit and operation of the charge pump 410 will not be described herein since they have been widely known in the art.

The clock divider 440 transmits the clocks (CLK, CLKB) from the clock generation unit (CLK) to the comparator unit 420 to operate the comparator unit 420.

The comparator 420 is synchronized with the clocks (CLK, CLKB), and compares a reference voltage (ref) with an input voltage (Vin) by receiving the input voltage (Vin) from an output port of the charge pump 410 and receiving the reference voltage (ref) through the reference voltage source, and allows the clock switch 430 to be operated by the first clock (CLK1) and the second clock (CLK2) by transmitting the compared signals to the clock switch 430 through the inverter 450, and therefore allows a charge pump to control an output voltage to correspond to the first clock (CLK1) and the second clock (CLK2).

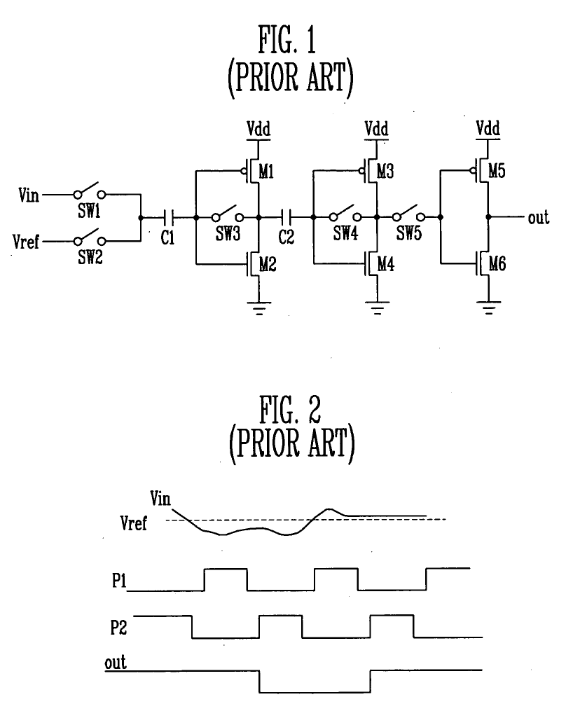

FIG. 5 is a circuit diagram showing one embodiment of the comparator used in the DC-DC converter shown in FIG. 4. Referring to FIG. 5, the comparator has an input unit and first to third inverters. The first to third inverters will be not described herein since they have essentially the same function as the comparator shown in FIG. 1.

Referring to FIG. 5, the input unit has an input voltage (Vin) connected with a first capacitor (C11) through the first switch (SW11) and a reference voltage (Vref) connected with a first capacitor (C11) through second and sixth switches (SW12, SW16). Also, the reference voltage (Vref) is charged into a third capacitor (C13) by the switching operations of the second switch (SW12) and the sixth switch (SW16). And, the third capacitor (C13) has a first electrode connected to the second switch (SW12) and a second electrode connected to the output port of the second inverter, and receives the voltage transmitted through the output port of the second inverter to control the voltage input to the first inverter.

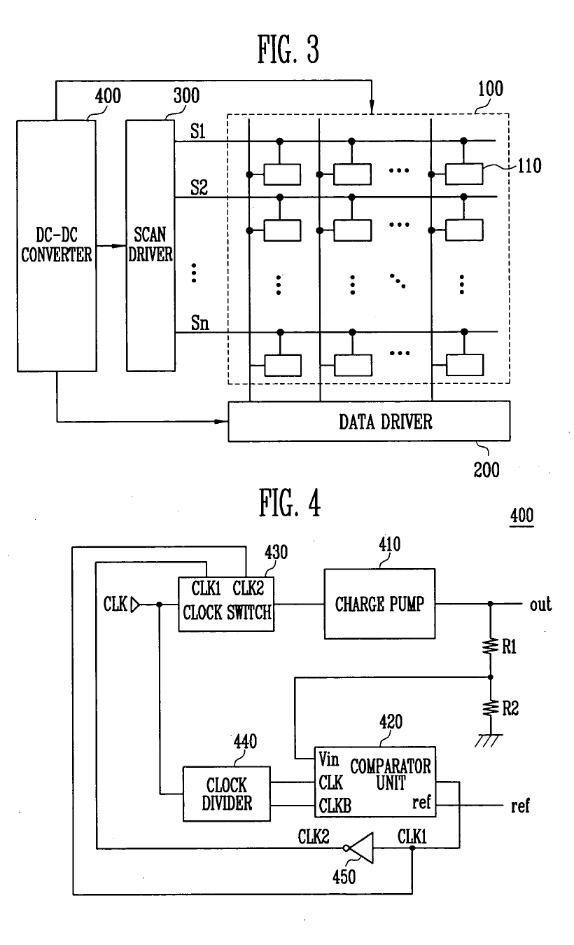

When the signals as shown in FIG. 2 are input, the first switch (SW11), the second switch (SW12), the third switch (SW13) and the fourth switch (SW14) conduct the switching operation according to the first control signal (P1), and the fifth and sixth switches (SW15, SW16) conduct the switching operation according to the second control signal (P2).

When the signals are input as shown in FIG. 2, if the first switch (SW11), the second switch (SW12), the third switch (SW13) and the fourth switch (SW14) are firstly turned on by the first control signal (P1) and the fifth and sixth switches (SW15, SW16) are turned off by the second control signal (P2), then the input voltage (Vin) is input to a first capacitor (C11), and the reference voltage (Vref) is transmitted to a third capacitor (C13). And then, when the first switch (SW11), the second switch (SW12), the third switch (SW13) and the fourth switch (SW14) are turned off by the first control signal (P1), and the fifth and sixth switches (SW15, SW16) are turned on by the second control signal (P2), then the first capacitor (C11) transmits the voltage stored in the third capacitor (C13). At this time, because the third capacitor (C13) is connected with the output port of the second inverter, the voltage stored in the third capacitor (C13) corresponds to the reference voltage and the voltage output in the output port of the second inverter. That is, the voltage at the output port of the second inverter is fed back by the third capacitor (C13) to control the voltage input to the first inverter.

Accordingly, an amplified difference between the input voltage (Vin) and the reference voltage (Vref) by means of the first capacitor (C11) is fed back to the input so as to improve the response characteristics of the signal since the range of the output voltage of the third inverter is further increased.

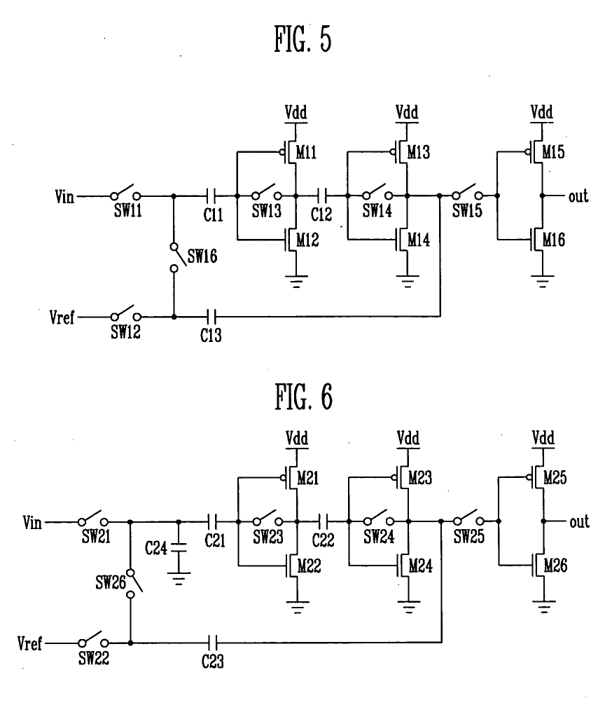

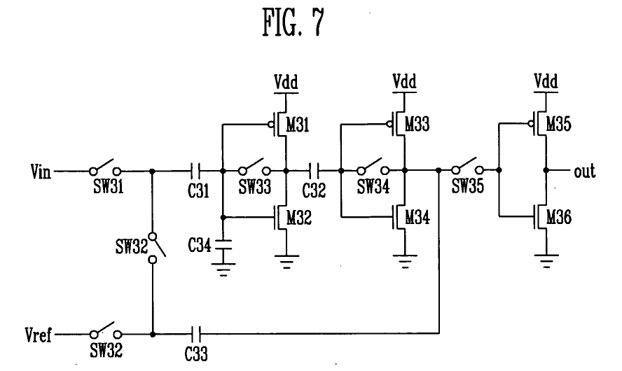

FIG. 6 is a circuit diagram showing another embodiment of the comparator used in the DC-DC converter shown in FIG. 4; and FIG. 7 is a circuit diagram showing the comparator used in the DC-DC converter shown in FIG. 4. Referring to FIG. 6, the comparator shown in FIG. 5 has a difference that it has a fourth capacitor (C24) between the first switch SW21 and the first capacitor (C21), as shown in FIG. 6. The fourth capacitor (C24) is configured to stabilize an early negative feedback operation.

Referring to FIG. 7, a fourth capacitor (C34) is connected to the gate of the first transistor (M31) and the gate of the second transistor (M32), as shown in FIG. 7, the same operation is achieved as in the fourth capacitor (C24) shown in FIG. 6 to stabilize a negative feedback operation.

According to the present invention, the DC-DC converter and the organic light-emitting display using the same may be useful to increase a response rate by varying the voltage input to the inverter to increase a changing level of the output voltage. Also, the DC-DC converter of the present invention may reduce power consumption by shutting off the inverter circuit to prevent flow of the current if the input/output unit is not operated.

Although certain embodiments have been shown and described in detail, the embodiments mentioned herein are just examples for the purpose of illustration only, and are not intended to limit the scope of the invention. Also, it would be appreciated by those skilled in the art that changes might be made to these embodiments without departing from the principles and spirit of the invention.

What is claimed is:

1. A comparator configured to receive an input voltage and a reference voltage and to determine an output corresponding to a difference between the input voltage and the reference voltage, the comparator comprising:
an input unit configured to transmit the input voltage to a first stage and to transmit the reference voltage and a feedback voltage to a second stage;
an amplification unit comprising at least one inverter configured to operate according to the input voltage transmitted to the first stage, the feedback voltage transmitted to the second stage, and the reference voltage;
a feedback unit configured to receive a voltage output in the amplification unit so as to generate a feedback voltage and to transmit the generated feedback voltage to the input unit so as to control the voltage transmitted to the amplification unit; and
an output unit configured to receive and output the output voltage of the amplification unit.

2. The comparator according to claim 1, wherein the first stage comprises an input switch connected with an input port configured to receive an input voltage, the input switch configured to switch the input voltage and to transmit the input voltage to the amplification unit; and wherein the second stage comprises:
a reference switch connected with a reference port configured to receive a reference voltage, the reference switch configured to switch the reference voltage and transmit the reference voltage to the feedback unit; and
a feedback switch configured to switch the feedback voltage and transmit the feedback voltage to the amplification unit.

3. The comparator according to claim 2, wherein the amplification unit is configured to receive the input voltage through the input switch and to receive the reference voltage through the feedback switch.

4. The comparator according to claim 3, wherein the input unit comprises a first capacitor configured to store the input voltage, and wherein the feedback unit comprises a second capacitor connected with the first capacitor and is configured to change the voltage stored in the first capacitor, wherein the feedback unit is configured to receive output signals of the amplification unit and to store a feedback voltage in the second capacitor.

5. The comparator according to claim 1, wherein the amplification unit comprises at least two inverters, and a third capacitor connected between the at least two inverters, wherein the third capacitor is configured to store a threshold voltage difference between the at least two inverters.

6. The comparator according to claim 2, wherein the input unit comprises a first capacitor configured to store the input voltage, and the comparator further comprises a fourth capacitor connected to the third switch and the first capacitor.

7. The comparator according to claim 2, wherein the input unit comprises a first capacitor configured to store the input voltage, and the comparator further comprises a fourth capacitor connected to the first capacitor and the amplification unit.

8. The comparator according to claim 1, wherein the output unit is configured to output a high level of signal when the reference voltage is less than the input voltage, and to output a low level of voltage when the reference voltage is greater than the input voltage.

9. The comparator according to claim 2, wherein the first and second switches perform a switching operation according to a first control signal, and the third switch conducts a switching operation according to a second control signal.

10. A DC-DC converter comprising:
a charge pump; and
a comparator configured to receive an input voltage and a reference voltage and to determine an output voltage corresponding to a difference between the input voltage and the reference voltage,
wherein the comparator comprises:
an input unit configured to transmit the input voltage to a first stage and to transmit the reference voltage and a feedback voltage to a second stage;
an amplification unit comprising at least one inverter configured to operate according to the input voltage transmitted to the first stage, the feedback voltage transmitted to the second stage, and the reference voltage;
a feedback unit configured to receive a voltage output in the amplification unit so as to generate a feedback voltage and to transmit the generated feedback voltage to the input unit so as to control the voltage transmitted to the amplification unit; and
an output unit configured to receive and output the output voltage of the amplification unit.

11. The DC-DC converter according to claim 10, wherein the first stage comprises an input switch connected with an input port configured to receive an input voltage, the input switch configured to switch the input voltage and transmit the input voltage to the amplification unit; and wherein the second stage comprises:
a reference switch connected with a reference port configured to receive a reference voltage, the reference switch configured to switch the reference voltage and transmit the reference voltage to the feedback unit; and
a feedback switch configured to switch the feedback voltage and transmit the feedback voltage to the amplification unit.

12. The DC-DC converter according to claim 11, wherein the amplification unit is configured to receive the input voltage through the input switch and to receive the reference voltage through the feedback switch.

13. The DC-DC converter according to claim 12, wherein the feedback unit receives the output signals of the inverter to store a predetermined voltage, and includes a second capacitor connected with the first capacitor to change the voltage stored in the first capacitor.

14. The DC-DC converter according to claim 10, wherein the amplification unit comprises at least two inverters, and a third capacitor connected between the at least two inverters, wherein the third capacitor is configured to store a threshold voltage difference between the at least two inverters.

15. The DC-DC converter according to claim 11, wherein the input unit comprises a first capacitor configured to store the input voltage, and the comparator further comprises a fourth capacitor connected to the third switch and the first capacitor.

16. The DC-DC converter according to claim 11, wherein the input unit comprises a first capacitor configured to store the input voltage, and the comparator further comprises a fourth capacitor connected to the first capacitor and the amplification unit.

17. The DC-DC converter according to claim 10, wherein the output unit is configured to output a high level of signal when the reference voltage is less than the input voltage, and to output a low level of voltage when the reference voltage is greater than the input voltage.

18. The DC-DC converter according to claim 11, wherein the first and second switches perform a switching operation according to a first control signal, and the third switch conducts a switching operation according to a second control signal.

19. An organic light-emitting display comprising:
a pixel unit configured to display an image corresponding to data signals and scan signals;
a data driving unit configured to transmit the data signals to the pixel unit;
a scan driving unit configured to transmit the scan signals to the pixel unit; and
a DC-DC converter configured to transmit a power supply to the pixel unit, the data driving unit and the scan driving unit,
wherein the DC-DC converter comprises:
a charge pump; and
a comparator configured to receive an input voltage and a reference voltage and to determine an output voltage corresponding to a difference between the input voltage and the reference voltage,
wherein the comparator comprises:
an input unit configured to transmit the input voltage to a first stage and to transmit the reference voltage and a feedback voltage to a second stage;
an amplification unit comprising at least one inverter configured to operate according to the input voltage transmitted to the first stage, the feedback voltage transmitted to the second stage, and the reference voltage;
a feedback unit configured to receive a voltage output in the amplification unit so as to generate a feedback voltage and to transmit the generated feedback voltage to the input unit so as to control the voltage transmitted to the amplification unit; and
an output unit configured to receive and output the output voltage of the amplification unit.

20. The organic light-emitting display according to claim 19, wherein the first stage comprises an input switch connected with an input port configured to receive an input voltage, the input switch configured to switch the input voltage and transmit the input voltage to the amplification unit; and wherein the second stage comprises:
a reference switch connected with a reference port configured to receive a reference voltage, the reference switch configured to switch the reference voltage and transmit the reference voltage to the feedback unit; and
a feedback switch configured to switch the feedback voltage and transmit the feedback voltage to the amplification unit.
